(19) United States
(12) Patent Application Publication
(10) Pub. No.: US 2014/0237775 A1
(43) Pub. Date: Aug. 28, 2014

(54) SECURITY SEALING SYSTEM INCORPORATING THE SEALING SYSTEM

(71) Applicant: ELC Produtos de Seguranca Industria e Comercio Ltda., Paraíba do Sul RJ (BR)

(72) Inventor: Andre de Lima Castro, Rio de Janeiro RJ (BR)

(21) Appl. No.: 14/349,286

(22) PCT Filed: Nov. 29, 2012
(86) PCT No.: PCT/BR2012/000481

§ 371 Date: Apr. 2, 2014

(30) Foreign Application Priority Data
Nov. 29, 2011 (BR) PI1107001-3

(51) Int. Cl. E05B 83/14

(52) U.S. Cl. CPC E05B 83/14
USPC 24/16 PB

(57) ABSTRACT

The present invention refers to a sealing system for a security seal or the like, comprising two parts (2, 3), the first part (2) defining a cavity (5) provided with first and second inlet openings (6, 7) adjacent each other, and having an internal tooth (8). The region between the two inlet openings (6, 7) comprises a base for the tooth (8). The second part (3) bears a locking pin (10) provided with a locking formation (11), which, upon being inserted into the cavity (5) through the first inlet opening (6), cooperates in locking relationship with the tooth (8). According to the invention, the first part (2) has a second internal tooth (9) on the opposite side of the first inlet opening (6) with respect to the first tooth (8), while the locking pin (10) on the second part (3) has second locking formation (12) that cooperates in locking relationship with the second tooth (9).

The present invention refers to a sealing system for use in security seals and the like, as well as to security seals using the system for sealing objects.

### PRIOR ART

Many sealing systems are known, in which a locking pin is received within a cavity or bore having internal teeth for cooperating and locking the pin, thus preventing relative movement between two parts. However, there are many drawbacks associated with seals of this type, for example:

a) although simple to manufacture, systems having bores that go totally through the part on which they are formed suffer from a considerably reduced degree of security, due to the availability of access to the teeth from the side of the bore opposite to that where the locking pin penetrates;

b) attempts to improve the degree of security of systems of the above type a) have been made, but they often fail to provide the ideally desired security and almost always raise manufacturing costs; and

c) systems in which the cavities that receive the locking pin have closed bottoms, thus preventing access to the pin after closure, are manufactured using injection moulds which have complex structures and are subject to all types of malfunction, once more increasing manufacturing costs.

Such drawbacks are eliminated by the sealing system of Brazilian Patent PI9201127-6 (corresponding to U.S. Pat. No. 5,542,724), which describes a “closed” capsule that has two openings on the side where the locking pin penetrates, one for the pin and the other for making space for a relatively simple injection mould tool deployed during manufacture. The other side (the bottom) of the capsule is totally closed.

In the sealing system disclosed in PI9201127-6, the region between the two openings in the capsule comprises the base of the internal capsule tooth, which cooperates with the locking pin and extends toward the capsule bottom from that base. The locking pin is formed with a lateral recess that cooperates with the tooth upon closing the system.

The sealing system of patent PI9201127-6 and the security seals that use them have had great acceptance both by the market for their high degree of security and also by manufacturers due to the possibility of using a relatively simple injection mould.

Notwithstanding, it has been found that, in certain circumstances, it is possible to tamper with the sealing system by inserting a needle or the like through the opening where the locking pin enters and manipulating the pin and/or the internal tooth so as to disengage one from the other.

### OBJECTIVE OF THE INVENTION

The objective of the present invention is to eliminate this possibility of tampering with the sealing system.

### SUMMARY OF THE INVENTION

According to the present invention, a sealing system for a security seal, which comprises:

a first part defining a cavity provided with first and second inlet openings adjacent each other, and having an internal tooth, the region between the two inlet openings comprising a base for the tooth and

a second part bearing a locking pin having a locking formation, which upon being inserted into the cavity through the inlet opening cooperates in locking relationship with the tooth in order to assume a sealed configuration, wherein the cavity is closed with the exception of the two inlet openings,

is characterized in that:

the first part has second internal tooth on the side opposite the first inlet opening with respect to the first mentioned tooth; and

the locking pin of said second part has second locking formation that cooperates in locking relationship with the second tooth.

Preferably, the locking formations on the locking pin comprise two recesses on respective opposite sides of the locking pin.

According to another embodiment of the invention, a security seal incorporates the above sealing system, the first part and the second part comprising a single piece having a hinge line, the first part being foldable over the second part.

According to another embodiment of the invention, a security seal incorporates the above sealing system, comprising two elongate rectangular strips with the longitudinal hinge line between the first strip and the second strip, which comprise, respectively, the first part and the second part of a plurality of such sealing systems, a plurality of cavities being formed longitudinally along the first strip and a corresponding plurality of locking pins being formed longitudinally along the second strip.

### BRIEF DESCRIPTION OF THE DRAWINGS

The present invention will be better understood from the following description given only by way of example and made with reference to the attached drawings, in which:

FIG. 1 is a sectional view of a security seal incorporating a sealing system according to the present invention;

FIG. 2 is a perspective view of another security seal incorporating a sealing system according to the present invention;

FIG. 3 is a plan view of the security seal illustrated in FIG. 2;

FIG. 4 is a upper perspective view, partially in section, of a security device for closing security envelopes, using a plurality of sealing systems according to the present invention, the device being in the closed and sealed configuration;

FIG. 5 is an underside view of the security device illustrated in FIG. 4;

FIG. 6 is a perspective view of a further security seal incorporating a sealing system according to the present invention, the seal being seen in an open configuration;

FIG. 7 is a view similar to that of FIG. 6, but in cross section;

FIG. 8 is a perspective view of the seal of FIG. 6, but in a closed configuration; and

FIG. 9 is a view similar to that of FIG. 8, but in cross section.

### DETAILED DESCRIPTION OF THE DRAWINGS

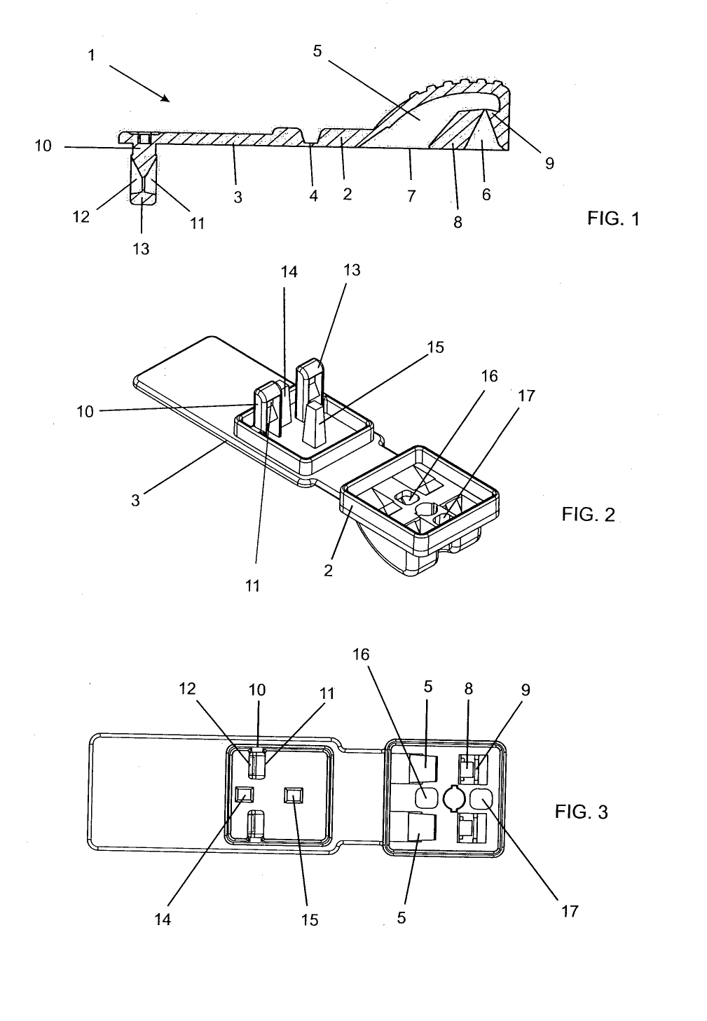

FIG. 1 shows in cross-section a security seal 1 molded by injection from a plastics material and composed of a first part 2 and a second part 3, connected by a hinge line 4. Part 2 defines a cavity 5 that is closed at the top (in the drawing) and formed underneath with a first inlet opening 6 and a second inlet opening 7.

The region between openings 6 and 7 comprises the base of a first tooth 8.

According to a feature of this invention, the capsule wall on the opposite side of the first opening 6 is formed to define a second tooth 9, the internal tips of the two teeth 8 and 9 being in mutual contact or approximately in mutual contact.

The second part 3 of seal 1 is formed with a locking pin 10, which is provided with two locking formations in the form of recesses 11 and 12, on opposite sides of the pin.

When the seal is closed by folding one of the parts 2 and 3 over the other, around hinge line 4, locking pin 10 enters opening 6 in the capsule defined by part 2 and is forced upward until its head 13 causes the tips of the capsule teeth 8 and 9 to expand elastically outwardly to allow passage of head 13. At this moment, the two teeth tend elastically to return towards their original configuration to, engaging the two recesses 11 and 12 in locking pin 10.

It will be understood that, with this double-tooth system, it becomes effectively impossible to release pin 10 from the cavity, significantly raising the degree of security provided by the sealing system.

FIG. 1 shows the application of the novel sealing system to a given security seal. FIGS. 2 and 3 show another security seal having two cavities and two locking pins, which further increases the system security. In FIGS. 2 and 3, the same reference numbers of FIG. 1 are used, where appropriate. Thus, there are two recesses 11 and 12 in each locking pin 10 and two teeth 8 and 9 in each cavity 5.

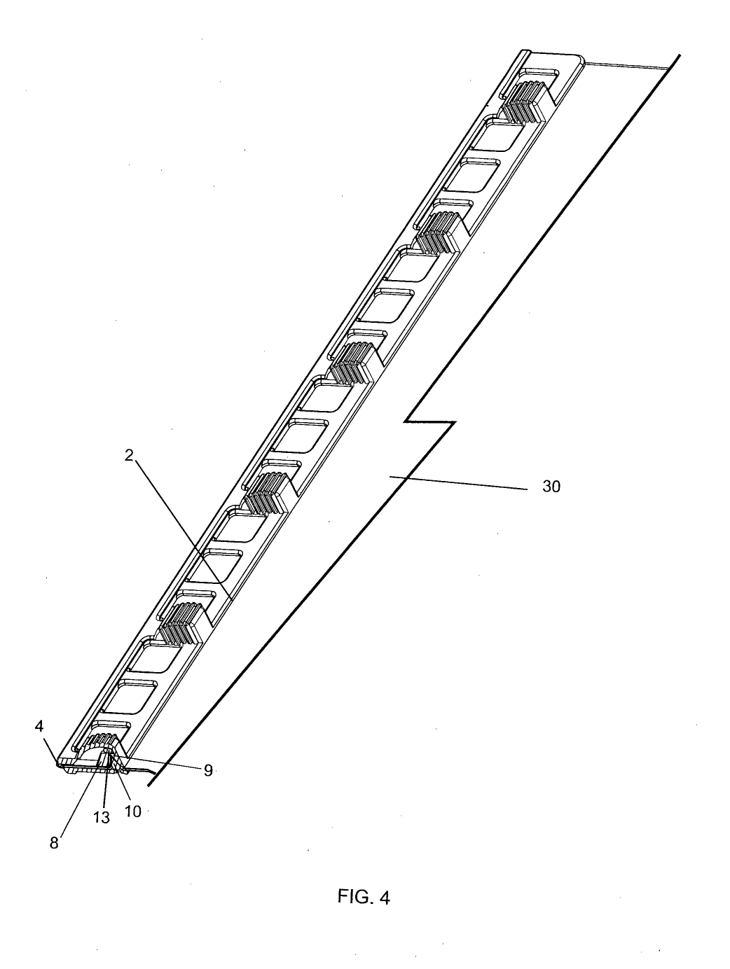

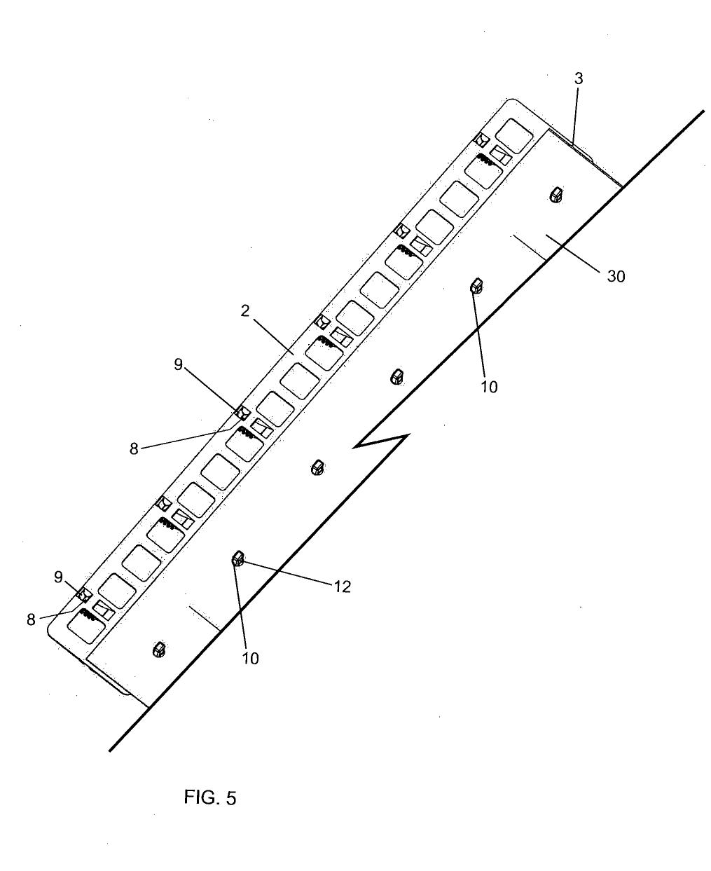

FIGS. 4 and 5 further show yet another security device used for closing and sealing security envelops. In this case, there is a plurality—six in the figures—of sealing systems distributed along the parts 2 and 3, this time in the form of elongate strips joined by the longitudinal hinge line 4.

FIG. 4 shows the security device open with the mouth of a security envelope 30 perforated by the lock pins 10 of the device. FIG. 5 shows the already closed security device, sealing the envelope 30, the part or the strip 2 folded around the hinge line 4 over the part or strip 3, with the locking pins 10 already locked in the cavities 5 on part 2. FIG. 4 clearly shows the pairs of teeth 8 and 9 common to each sealing system at the left end where the drawing is in cross section.

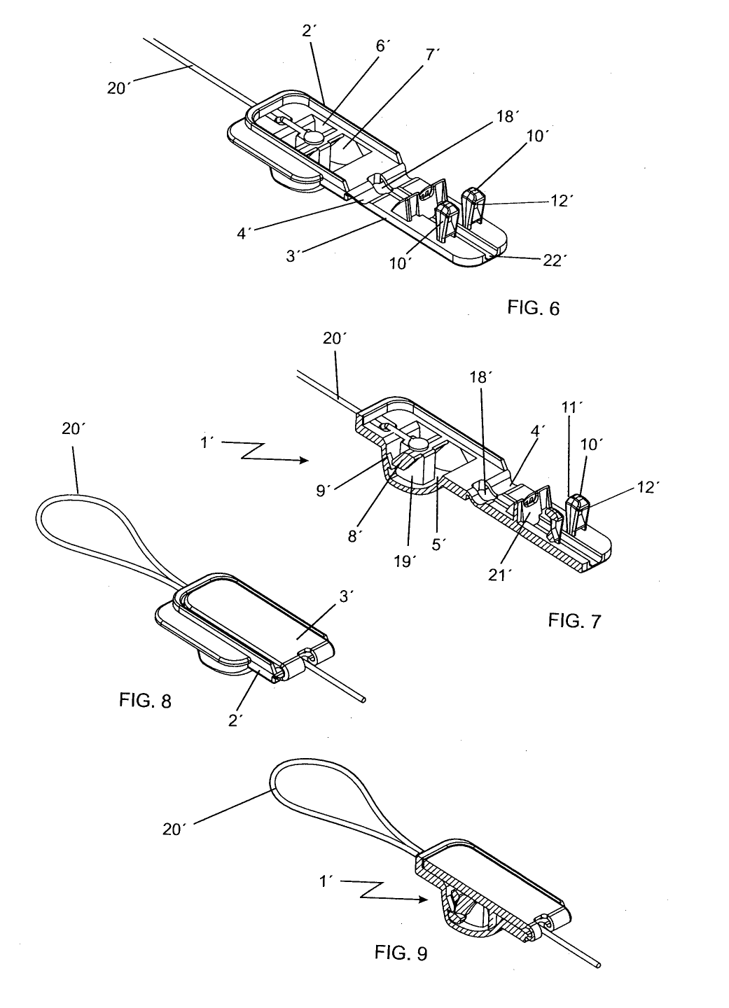

FIGS. 6 to 9 show another security seal incorporating the closing system of the present invention. In this case, a seal 1′ is composed of first a part 2′ and a second part 3′, connected by a hinge part 4′. In the middle of hinge part 4′, there is a orifice 18′. Part 2′ defines a cavity 5′ closed at the bottom (in the drawing) and formed, at the top, with a first inlet opening 6′ and a second inlet opening 7′.

The region between openings 6′ and 7′ comprise the base of two first teeth 8′, one on each side of a central rectangular post 19′. According to the main feature of this invention, the capsule wall on the opposite side of first opening 6′ is formed to define two second teeth 9′, the internal tip of the two teeth 8′ being in respective mutual contact or approximately mutual contact with the internal tips of the two teeth 9′.

The second part 3′ of the seal 1 is formed with two locking pins 10′ similar to pins 10 of FIGS. 2 and 3, and each is provided with two locking formations in the form of recesses 11′ and 12′, on opposite sides of the respective pin 10′.

The security seal 1′ of FIGS. 6 to 9 further includes a sealing thread 20′ made of plastic or wire, the end 21′ of which is fastened to the post 19′ on the part 2′ of the seal. The other end of the sealing thread 20′ is free (loose) when the seal 1′ is in an open configuration, prior to use. Upon application of the seal, the free end of the thread 20′ is passed through openings in the object to be sealed (for instance, a light meter), then folded backward and inserted through orifice 18′ in seal hinge 4′. The seal is then closed by folding part 3′ over the part 2′, the locking pins 10′ penetrating cavity 5′ to be locked by cooperation between the tips of teeth 8′ and 9′ and recesses 11′ and 12′, in the same way as the seal illustrated in FIGS. 2 and 3.

It will be understood that the new sealing system can be used in many different types of security seal without departing from the scope of the present invention, which is based on the use of a locking pin on one part with locking formations on both sides that cooperate with two opposite teeth within the cavity of the other part.

1-4. (canceled)

5. A sealing system for a security seal or the like, said sealing system comprising:
a first part (2;2′) defining a cavity (5; 5′), the cavity comprising:
first and second inlet openings (6, 7; 6′, 7′) adjacent each other; and
an internal tooth (8;8′), the region between the two inlet openings (6,7; 6′, 7′) comprising the base of the tooth (8;8′); and
a second part (3;3′) bearing a locking pin (10;10′) having a locking formation (11 ;11 ′), wherein:
the locking pin, upon being inserted into the cavity (5;5′) through said first inlet opening (6;6′), cooperates in locking relationship with the tooth (8;8′) to assume a sealed configuration;
the cavity (5; 5′) is closed with the exception of said first and second inlet openings (6,7;6′,7′);
said first part (2;2′) has a second internal tooth (9;9′) on the opposite site of the first inlet opening (6;6′) with respect to the first tooth (8;8′); and
the locking pin (10;10′) on said second part (3;3′) has a second locking formation (12; 12′) that cooperates in locking relationship with the second tooth (9;9′).

6. A sealing system according to claim 5, wherein said locking formations on the locking pin (10; 10′) comprise two recesses (11 , 12; 11′, 12′) on opposite sides of the locking pin (10).

7. A security seal incorporating the sealing system as defined in claim 5, wherein the first part (2;2′) and the second part (3;3′) are a single piece having a hinge line (4;4′), the first and second parts (2, 3; 2′, 3′) being foldable over each other.

8. A security seal incorporating the sealing system as defined in claim 5, said security seal comprising two elongate rectangular strips 02, 3) with a longitudinal hinge line (4) between the first and second strips, which comprise, respectively, the first part and the second part of a plurality of sealing systems as defined in claim 1 or 2, a plurality of cavities (5) being formed longitudinally along the first strip (2) and a plurality of corresponding locking pins being formed longitudinally along the second strip (3).
